(19) United States
(12) Patent Application Publication
(10) Pub. No.: US 2026/0136097 A1
(43) Pub. Date: May 14, 2026

(54) IMAGE CAPTURING APPARATUS CAPABLE OF MANUAL FOCUSING, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: YASUYOSHI MIYAZAKI, Kanagawa (JP)

(21) Appl. No.: 19/366,439

(22) Filed: Oct. 22, 2025

(30) Foreign Application Priority Data
Nov. 13, 2024 (JP) 2024-198068

(51) Int. Cl. H04N 23/67; H04N 23/611; H04N 23/71

(52) U.S. Cl. CPC H04N 23/675; H04N 23/611; H04N 23/672; H04N 23/71

(57) ABSTRACT

An image capturing apparatus that enables stable exposure follow-up while obtaining an appropriate image capturing effect without unnatural blur variation when an object to be focused is switched by manual focusing. The image capturing apparatus includes an image capturing system to capture an image, a focusing mechanism to adjust the focal position in capturing an image, a memory device that stores instructions, and a processor that executes the instructions to detect objects from the image, calculate depths of field within which the objects falls, respectively, perform control based on a program diagram relating to exposure in capturing an image, and change the program diagram in a case where the focal position is adjusted by manual focusing and it is determined that the objects respectively falling within the depths of field calculated satisfy a predetermined condition.

### BACKGROUND

### Field of the Technology

The aspect of the embodiments relates to an image capturing apparatus capable of manual focusing, a control method therefor, and a storage medium storing a control program therefor.

### Description of the Related Art

In a case where photometry control is performed in a digital camera, there is a known method that divides a screen into blocks in a lattice pattern, obtain brightness values in the blocks, and performs exposure control based on an evaluation value obtained from an average value of the obtained brightness values. The number of exposure correction steps for converging a captured image to a proper brightness value is found from the evaluation value, and is fed back to the exposure control such as an aperture value, a shutter speed, and an ISO speed, whereby the exposure can be properly maintained.

There is also a method that detects a face or a head of an object in a captured image and calculates an exposure correction value that achieves a proper brightness for the obtained face or head. It is possible to calculate similar exposure correction values for a plurality of detected objects, respectively. In addition, when a plurality of objects are included within an angle of view, there is a case where the objects are located at positions separated in a depth direction. A method of displaying a depth of field so as to smooth movement of a focal position between the objects by manual focusing in such a case is also disclosed (for example, see Japanese Patent Laid-Open No. H9-61923).

However, a desired image may not be obtained even by using the method described in the above publication. For example, a case of capturing a moving image that emphasizes each of two object persons located at positions separated in the depth direction using an effect of blur is assumed.

Here, when the aperture is changed to a small aperture side in order to adjust the exposure to the bright object on the front side, the depth of field finally becomes deep, and the effect of emphasizing the object using the blur is halved when moving the focal position from the near object person to the far object person.

### SUMMARY

The present disclosure provides an image capturing apparatus, a control method therefor, and a storage medium storing a control program therefor that enable stable exposure follow-up while obtaining an appropriate image capturing effect without unnatural blur variation when an object to be focused is switched by manual focusing.

Accordingly, an aspect of the embodiments provides an image capturing apparatus capable of manual focusing to adjust a focal position according to a user operation, the image capturing apparatus including an image capturing system to capture an image, a focusing mechanism to adjust the focal position in capturing an image, a memory device that stores a set of instructions, and at least one processor that executes the set of instructions to detect objects from the image, calculate depths of field within which the objects falls, respectively, perform control based on a program diagram relating to exposure in capturing an image, and change the program diagram in a case where the focal position is adjusted by manual focusing and it is determined that the objects respectively falling within the depths of field calculated satisfy a predetermined condition.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of an image capturing apparatus according to an embodiment of the present disclosure.

FIG. 2A is an entire flowchart illustrating operations of the image capturing apparatus of the embodiment of the present disclosure, and FIG. 2B is a flowchart illustrating an AE process using a depth of field.

FIG. 3 is a flowchart illustrating a program diagram change determination process executed in the image capturing apparatus according to the embodiment of the present disclosure.

FIGS. 4A and 4B are views for describing a distance map.

FIGS. 5A, 5B, and 5C are views for describing issues.

FIG. 6 is a program diagram for describing the issues.

FIGS. 7A to 7E are views illustrating a captured image, blocks of the image divided in a lattice pattern, a block integration image, and an object area in the image.

FIG. 8 is a program diagram of the embodiment of the present disclosure.

FIG. 9 is a view illustrating a relationship between the depth of field and the corresponding aperture.

FIG. 10 is a program diagram of the embodiment.

### DESCRIPTION OF THE EMBODIMENTS

Hereinafter, an embodiment of the present disclosure will be described in detail with reference to the attached drawings. However, the configuration described in the following embodiment is merely an example, and the scope of the present disclosure is not limited by the configuration described in the embodiment. The same or similar components in the attached drawings are denoted by the same reference numerals, and redundant descriptions thereof will be omitted. A “depth of field” described below refers to a distance range in which an object is in focus and is clearly viewed with a focused distance as the center. Hereinafter, a configuration and operations of the image capturing apparatus 10 according to the embodiment of the present disclosure will be described.

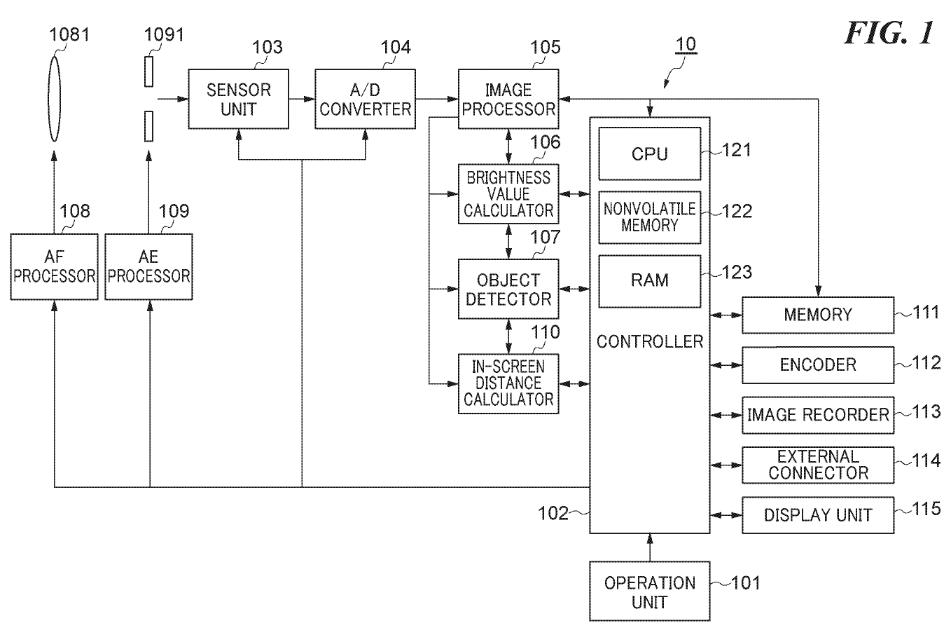

FIG. 1 is a block diagram illustrating a configuration example of the image capturing apparatus 10. In the present embodiment, a digital camera is illustrated as the image capturing apparatus 10, but the image capturing apparatus 10 is not limited thereto. For example, the image capturing apparatus 10 may be various electronic apparatuses, such as a smartphone and a tablet, having an image capturing function.

The image capturing apparatus 10 includes an operation unit 101, a controller 102, a sensor unit 103, an A/D converter 104, an image processor 105, a brightness value calculator 106, an object detector 107, an in-screen distance calculator 110, an AF processor 108, and an AE processor 109. The image capturing apparatus 10 further includes a memory 111, an encoder 112, an image recorder 113, an external connector 114, and a display unit 115. Each of the components of the image capturing apparatus 10 is connected to the controller 102 so as to communicate required information.

The operation unit 101 is used by an operator to input various instructions, and includes switches, buttons, and the like. The operation unit 101 also includes a shutter switch and a touch sensor. The touch sensor can be operated by a touch operation on the display unit 115. The controller 102 includes a CPU 121, a nonvolatile memory 122, and a RAM 123. The CPU 121 can achieve various functions necessary in the present embodiment by executing programs stored in the nonvolatile memory 122. As an example, the controller 102 controls an operation of each unit illustrated in FIG. 1 in accordance with an instruction given from the operation unit 101. The controller 102 performs various controls based on a program diagram related to an exposure in capturing an image described later. Further, the operation unit 101 includes an operator that can be operated for manual focus (MF). An optical system and the controller 102 are constructed so as to perform an image capturing operation according to the MF operation. That is, the image capturing apparatus 10 is configured to be able to manually adjust a focal position according to a user operation.

The sensor unit 103 receives light incident via the optical system including a lens 1081 and a mechanical structure 1091 like a diaphragm, and outputs an analog image signal by outputting charge corresponding to an amount of light. Therefore, the sensor unit 103, the lens 1081, and the mechanical structure 1091 constitute an image capturing unit (image capturing system) in the image capturing apparatus 10. The sensor unit 103 is constituted by, for example, a CMOS image sensor in which pixels are arranged in a matrix. The A/D converter 104 performs sampling, gain adjustment, A/D conversion, and the like on the analog image signal output from the sensor unit 103, thereby outputting a digital image signal. The image processor 105 performs various image processes on the digital image signal output from the A/D converter 104 and outputs a processed digital image signal. For example, the image processor 105 converts the digital image signal received from the A/D converter 104 into a YUV image signal and outputs the YUV image signal.

The brightness value calculator 106 calculates a brightness evaluation value of a screen area using the image signal obtained from the image processor 105. The object detector 107 detects an object using the digital image signal obtained from the image processor 105. An object detected by the object detector 107 is a person, and an area of a face and head of the person in a screen is obtained. The following well-known object detection methods (1) to (3) are exemplified. (1) A method of extracting an area from a contour shape of a human body by pattern matching. (2) A method of detecting important parts with features such as eyes, a nose, and a mouth and detecting a head area including the important parts. (3) A method using an algorithm in which a face area of a person is learned by machine learning.

For example, the method using the machine learning performs learning by associating respective granularity concepts from an entire image to details of an object as a hierarchical structure. In the case of learning a person, it is possible to learn using person images including various races, ages, genders, face orientations, and hair. Although a person is described as an object in the present embodiment, an animal, a stationary object, or the like may be an object. And the object detection method is not limited to the above methods (1) to (3), and another object detection method may be employed.

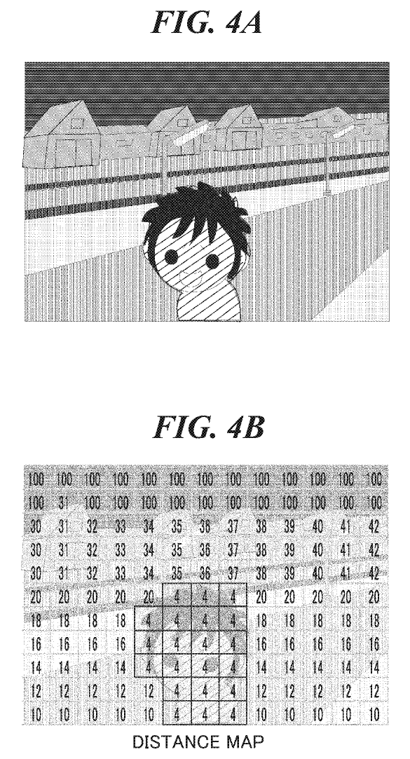

The in-screen distance calculator 110 calculates a distance to an object. A screen illustrated in FIG. 4A is divided into areas in a lattice pattern as illustrated in FIG. 4B, and distances are calculated for the respective areas. In the present embodiment, it is assumed that a distance map is obtained from defocus information obtained using image plane phase difference pixels. Since the image plane phase difference pixels for distance measurement are incorporated in the sensor unit 103, the sensor unit 103 can obtain a distance map by obtaining distance measurement results for the areas while obtaining an image capturing signal. The in-screen distance calculator 110 obtains the distance to each object and calculates the depth of field of each of the plurality of objects. Numerical values 4 to 100 in FIG. 4B indicate distances to objects in the respective areas.

The AF processor 108 (a focusing mechanism) drivingly controls the lens 1081 based on the image obtained by the image processor 105, and drives a focus lens to focus on the detected object. When the manual focus is selected, the user can freely control the focus lens position manually. The AE processor 109 calculates a difference from the proper brightness based on the image obtained by the image processor 105, and controls the mechanical structure 1091 so as to eliminate the difference. The mechanical structure 1091 includes a diaphragm, a shutter, and the like. The diaphragm controls a light amount by adjusting an opening degree of diaphragm blades. The shutter is arranged in front of the sensor unit 103, and the light amount is controlled by a time when the shutter is opened and closed, so that an exposure value is controlled.

The memory 111 temporarily stores image data being processed by the controller 102, the image processor 105, and the encoder 112. The encoder 112 converts the format of the output digital image signal (image data) into a format such as JPEG, and outputs the converted signal to the image recorder 113. The image recorder 113 records the format-converted image data output from the encoder 112 in a memory (not shown) in the image capturing apparatus 10 or an external memory such as a memory card mounted on the image capturing apparatus 10.

The external connector 114 connects with an external apparatus such as an external monitor or a personal computer. For example, when an external monitor is connected to the external connector 114, it is possible to display a screen displayed on the display unit 115 on the external monitor. The display unit 115 is configured by a liquid crystal display device or the like, and displays an image (a digital image signal) output from the image processor 105.

The image processor 105, the brightness value calculator 106, the object detector 107, and the in-screen distance calculator 110 may be achieved by the CPU 121 executing software, or may be achieved by dedicated hardware such as an ASIC. In addition, although the image processor 105, the brightness value calculator 106, the object detector 107, and the in-screen distance calculator 110 are configured separately from the controller 102 in FIG. 1, the present disclosure is not limited to such a configuration. At least some of the functions of the image processor 105, the brightness value calculator 106, the object detector 107, and the in-screen distance calculator 110 may be included in the controller 102. In this case, the part of the functions included in the controller 102 may be configured to be achieved by the CPU 121 executing a program stored in the nonvolatile memory 122.

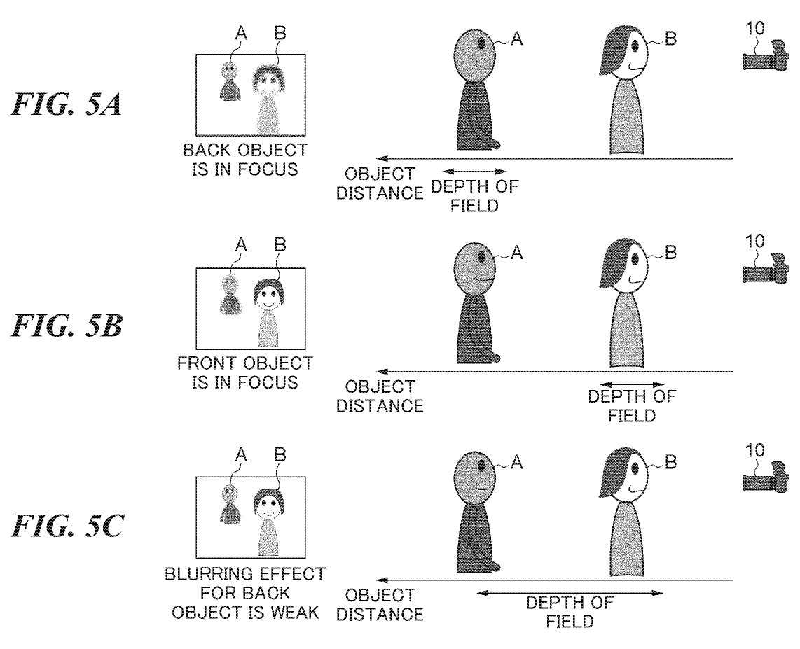

Here, the problem to be solved by the present disclosure will be described with reference to FIGS. 5A, 5B, and 5C. It is assumed that there are two persons A and B who are located at positions shifted in a depth direction (a left-right direction in FIGS. 5A, 5B, and 5C). A case where a user desires a moving image that captures a shift from a state where the object A before the movement of the focal position is emphasized (FIG. 5A) to a state where the object B after the movement of the focal position is emphasized (FIG. 5B) by utilizing a “blurring effect” due to the difference in the depth of field is assumed. That is, this is a case that the user desires the moving image that captures the shift from the state where the back (left) object A is in focus to the state where the front (right) object B is in focus. In this case, the depth of field at the start of the image capturing covers only the back object A, and does not cover the front object B. Next, when the state where the back-and-dark object A is in focus is shifted to the state where the front-and-bright object B is in focus, the main object is changed the bright object B, and thus exposure variation occurs.

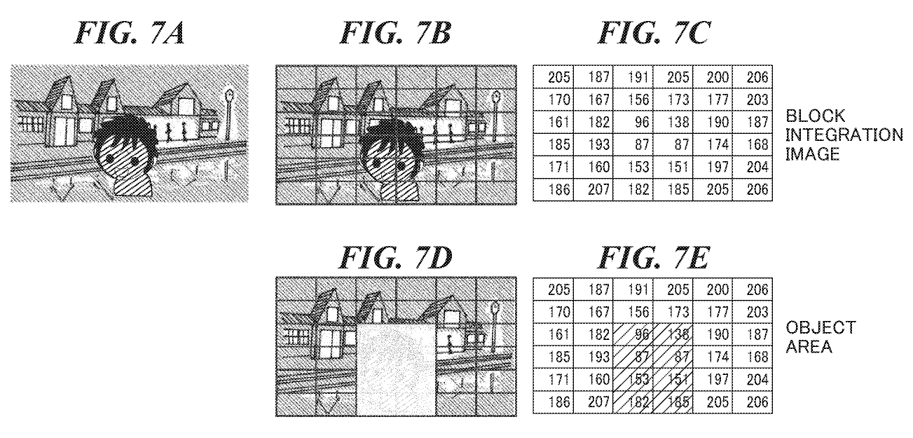

Here, a method of calculating proper exposure in the screen in the present embodiment will be described. First, the entire screen shown in FIG. 7A is divided into blocks in a lattice pattern as shown in FIG. 7B, and “brightness values (Bv)” obtained in the respective blocks are multiplied by weights of the respective blocks to obtain an “average brightness value” (block integration). The weights of the respective blocks are set by numerals in a matrix as shown in FIG. 7C. The CPU 121 calculates a brightness difference between the average brightness value and the target brightness value, and performs exposure control so as to eliminate the difference by adjusting the aperture value, shutter speed, ISO speed, and the like.

When the main object exists as indicated by a bright rectangle in FIG. 7C, the weights in the area of the main object may be set to be heavier than that of the other area. That is, the weights of the eight blocks hatched in black in FIG. 7E corresponding to the main object may be set to be higher in order to set an additional weight for the main object when calculating a photometric value obtained by additionally averaging the entire screen brightness value and the object brightness value. In this case, the calculated average brightness value is likely to be affected by the object brightness value. When the object brightness value is high, the exposure likely decreases and when the object brightness value is low, the exposure likely increases. FIG. 7E indicates only the position of the main object with the eight blocks for ease of understanding, and the weights in FIG. 7C are followed without particularly changing the weights.

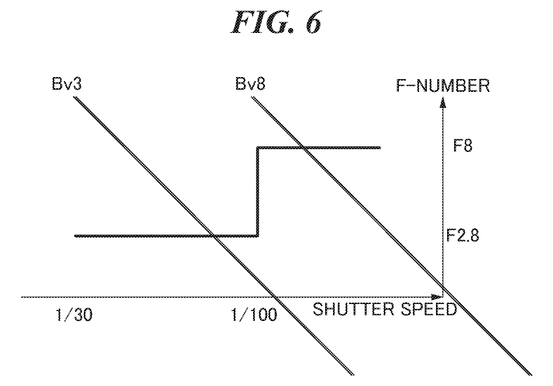

The exposure follow-up in the present embodiment is controlled by a program diagram that defines a combination of the aperture value, shutter-speed, and ISO speed designed in advance to vary according to the brightness value (Bv). FIG. 6 illustrates an example of the program diagram used in exposure control of a camera assumed in the present embodiment, a vertical axis denotes “F-number (an aperture value)” and a horizontal axis denotes “a shutter speed”. An ISO speed shall be fixed at “100”. As described above, the depth of field has a characteristic that the depth of field becomes shallower as the F-number (aperture value) becomes smaller and the depth of field becomes deeper as the F-number becomes larger.

Further, an in-focus range becomes narrower and blur becomes larger as the aperture value decreases. On the other hand, the in-focus range becomes wider and the blur becomes smaller as the aperture value increases. The program diagrams including the diagram mentioned below are graphs each of which shows the relationship between the shutter speed (the horizontal axis) and the F-number (the vertical axis), and also shows straight lines corresponding to the object brightness values (external light brightness values) Bv3 and Bv8.

When the main object is changed by moving the focal position by manual focusing, so that an exposure variation from “Bv3” to “Bv8” occurs, the F-number is changed from “F2.8” to “F8” with reference to the program diagram in FIG. 6. As a result, the depth of field becomes deep, and both the objects A and B fall within the same depth of field as shown in FIG. 5C, and an emphasizing effect with blur may be reduced by half. The present embodiment solves the issue that the exposure control based on the object area and depth of field reduces the emphasizing effect with the blur in half, and enables to obtain an appropriate image capturing effect without unnatural blur variation when the object is switched by manual focusing. Hereinafter, the operation of the image capturing apparatus 10 will be described in detail.

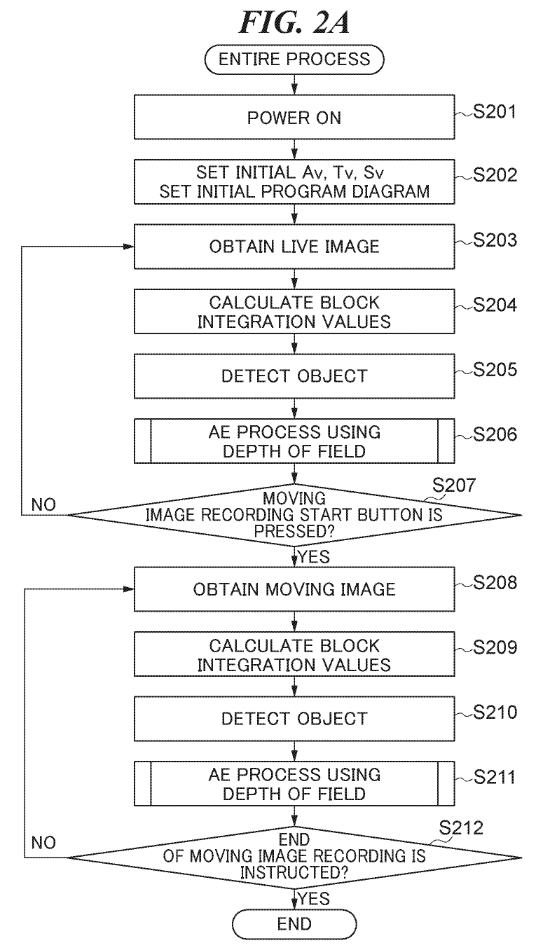

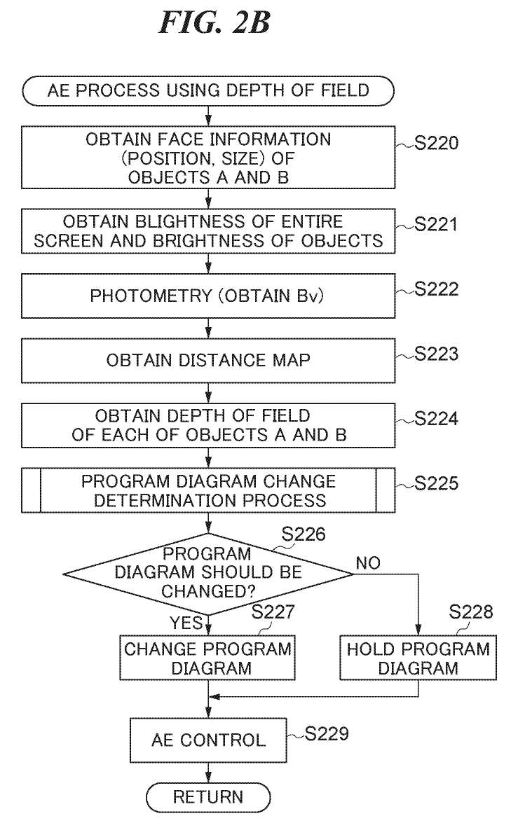

Next, the imaging operation of the image capturing apparatus 10 will be described with reference to FIGS. 2A and 2B. FIG. 2A is an entire flowchart illustrating an image capturing operation. First, when an operator (a user) operates a power switch included in the operation unit 101 to turn ON, the controller 102 detects this and supplies power to components constituting the image capturing apparatus 10 in step S201.

When the power is supplied to the components of the image capturing apparatus 10, the shutter opens and the sensor unit 103 receives light incident via the lens 1081 and the mechanical structure 1091 disposed in a front part of the camera. In step S201, the aperture value Av, shutter speed Tv, and ISO speed Sv in activation is set to initial values (initial Av, Tv, Sv) registered in advance, and the program diagram to be used is set to an LV (Live View) program diagram (initial LV program diagram) that is initially set. The live view refers to displaying a video from the sensor unit 103 on a liquid crystal monitor mounted on a back side of the camera, and the user can capture a moving image while checking an object displayed on the liquid crystal monitor instead of a finder. In addition, the program diagram in FIG. 6 shall be used as the LV program diagram.

In step S203, the sensor unit 103 reads accumulated charge corresponding to an incident light amount and outputs the charge as an analog image signal to the A/D converter 104. The A/D converter 104 performs sampling and gain adjustment on the analog image signal output from the sensor unit 103 to convert into a digital image signal, and outputs the digital image signal. The image processor 105 performs various image processes on the digital image signal output from the A/D converter 104 and outputs the processed digital image signal as live image data (live image obtainment).

In step S204, the brightness value calculator 106 divides the entire screen into blocks in a lattice pattern using the obtained image data, and calculates block integration by multiplying a brightness value of each block by the weight (calculation of the block integration: see FIGS. 7B and 7C).

In step S205, the object detector 107 detects an object from the image data obtained in step S203 (object detection). Here, the object detector 107 detects a person in the image and obtains a face area or a head area thereof. Since these areas are converted into coordinates on the blocks calculated in step S204, the brightness of the face can be calculated together with the brightness evaluation value calculated by the brightness value calculator 106. As shown in FIG. 7C, a “block integration image” is obtained by averaging the blocks in the lattice pattern in the screen. Further, the object is detected using the same original image (FIG. 7A) to extract the area, the blocks in which the object exists are determined, and the brightness values of the blocks corresponding to the coordinates are additionally averaged. Thus, the object area brightness is obtained as shown in FIG. 7E.

In step S206, the brightness value calculator 106, the object detector 107, the in-screen distance calculator 110, and the AE processor 109 execute the AE process using the depth of field and obtain an exposure value used for capturing an image. Further, the AE process using the depth of field in step S206 will be described with reference to FIG. 2B.

FIG. 2B is a flowchart illustrating the AE process using the depth of field. As shown in FIG. 2B, first, in step S220, the object detector 107 obtains face information (positions and sizes) of the objects (obtains the face information of the objects A and B). In step S221, the brightness value calculator 106 obtains a brightness evaluation value of the entire screen and brightness evaluation values of the objects using the face information and the brightness values obtained by the block integration. Since the present embodiment assumes the focus movement between a plurality of persons (a plurality of objects), the object evaluation values are calculated for the number of detected persons. In step S222, the final “photometric value (Bv)” is calculated. At this time, the in-screen distance calculator 110 and the object detector 107 determine that the person who is most focused is a “main object”, and the AE processor 109 performs photometry by combining the “object evaluation value” and the “entire screen evaluation value” while giving the largest weight for the person (object).

In step S223, a distance is calculated for each of the blocks obtained by dividing the screen into the lattice pattern as shown in FIG. 4B. In the present embodiment, a case is assumed in which a “distance map” is obtained from defocus information obtained using the imaging plane phase difference pixels. The imaging plane phase difference pixels for measuring distances are incorporated in the sensor unit (image sensor) 103, and the “distance map” is obtained by obtaining the distance measurement results of the pixels while obtaining the image capturing signal. In this “distance map”, the value is set to be smaller as the object distance is shorter, and the value is set to be larger as the object distance is longer, so that the entire screen is covered. Next, in step S224, the in-screen distance calculator 110 calculates the depth of field of the object. When a plurality of objects exist in the screen, the in-screen distance calculator 110 calculates the depth of field of each of the objects (A, B) in step S224.

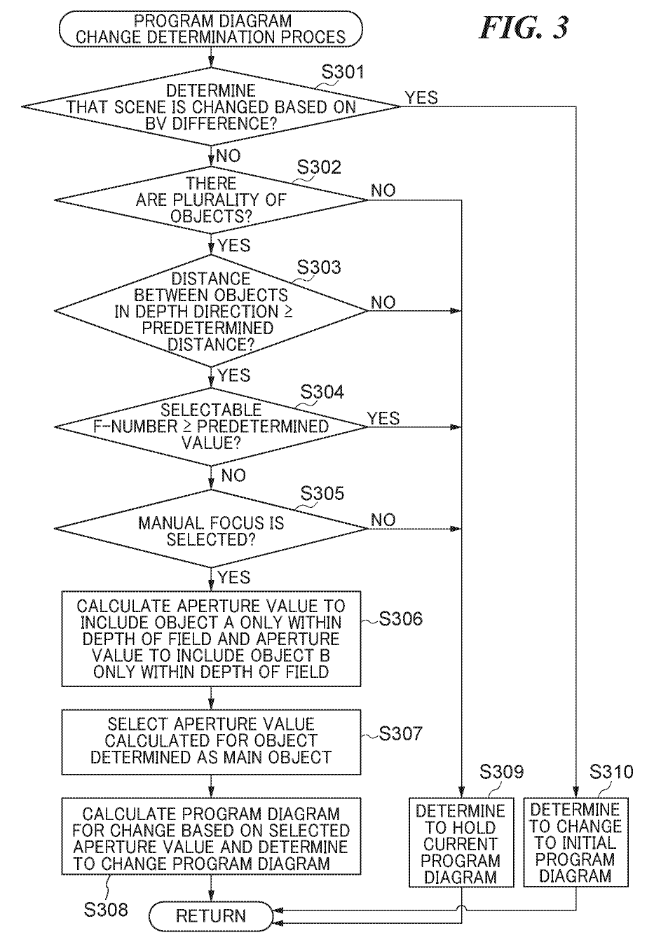

Next, in step S225, the AE processor 109 performs a diagram change determination process, the details of which will be described later with reference to FIG. 3. In step S226, the AE processor 109 determines, in step S225, whether the program diagram should be changed on the basis of the result of the diagram change determination process. When it is determined that the program diagram should be changed (YES in step S226), the AE processor 109 changes, in step S227, the current program diagram to a program diagram calculated in a process in step S308 described below or to the initial program diagram (the program diagram is changed). On the other hand, when it is determined that the program diagram should not be changed (NO in step S226), the AE processor 109 holds the current program diagram in the memory 111 in step S228 (the program diagram is held). Details of these steps S226, S227, and S228 will be described after the description about FIG. 3.

Then, in step S229, the AE processor 109 performs AE control, that is, calculates the exposure value in capturing an image using the photometric value obtained by the above-described calculation and the set program diagram.

After the exposure value is calculated in step S229, the process returns to FIG. 2A, and it is determined in step S207 whether a moving image recording start button is pressed. When it is determined that the press operation is performed (YES), the process proceeds to a step S208, and when it is determined that the pressing operation is not performed (NO), the process returns to the step S203. That is, in step S208, the controller 102 instructs the start of the moving image recording using the exposure value obtained by the AE process in step S229 and obtains the moving image. On the other hand, when it is determined that the moving image recording start button is not pressed, the process returns to the step S203, and the process from the step S203 to the step S206 is repeated.

Next, the image capturing apparatus 10 records the moving image. Since the operation from the moving image obtainment in step S208 to the moving image recording end in step S211 is the same as the operation during the live view standby from the step S203 to the step S206 described above, a redundant description will be omitted. Then, in step S212, the controller 102 determines whether the moving image recording end is instructed. When the controller 102 determines that the moving image recording end is instructed (YES), the image capturing ends, and when the controller 102 determines that the moving image recording end is not instructed (NO), the process returns to the step S208. In a case of the end of the image capturing, the encoder 112 converts the digital signal output from the image processor 105 into a format such as MPEG and outputs the converted signal to the image recorder 113. The image recorder 113 records the format-converted image data in an external memory such as a memory card.

Next, the program diagram change determination process executed using the object information and the distances in step S225 will be described with reference to FIG. 3. FIG. 3 is a flowchart illustrating the program diagram change determination process.

First, in step S301, the brightness value calculator 106 determines whether a scene is changed. The transition of the depth of field in the present embodiment is based on the assumption that an image is captured at a stable angle of view, and if the image capturing scene changes significantly, the effect thereof is reduced, and therefore, it is necessary to check the change of scene. For example, the brightness value calculator 106 determines that a scene is changed if the difference between the current photometric value and the held previous photometric value is equal to or more than a predetermined step number difference. That is, when the brightness value variation in the screen is equal to or more than a preset predetermined value, it is determined that the scene is changed. It is also possible to determine that the scene is changed when variation of a gyro signal output by a gyrosensor built in the image capturing apparatus 10 is equal to or more than a predetermined value.

When it is determined in step S301 that the scene is changed (YES), the process proceeds to a step S310, and when it is determined that the scene is not changed (NO), the process proceeds to a step S302.

When it is determined that the scene is changed, there is a high possibility that an exposure variation affected by the scene change will occur, and thus, the AE processor 109 determines that the program diagram should be changed to the initial program diagram in step S310 (change to the initial program diagram). When it is determined that the scene is not changed, the in-screen distance calculator 110 determines in step S302 whether there are a plurality of objects within the angle of view. When it is determined that there are a plurality of objects (YES), the process proceeds to a step S303, and when it is determined that there are not a plurality of objects (NO), the process proceeds to a step S309. Next, in step S303, the in-screen distance calculator 110 determines whether the plurality of objects are located at a plurality of positions separated by a predetermined distance or more in the depth direction. When it is determined that the objects are located at the plurality of positions separated by the predetermined distance or more in the depth direction (YES), the process proceeds to a step S304, and when it is determined that the distance between the positions of the objects is less than the predetermined distance (NO), the process proceeds to the step S309.

Although an arbitrary fixed distance is assumed for the determination of the object distance in the depth direction in the present embodiment, an arrangement in which the depths of field of the respective objects do not overlap may be added as a condition. In this manner, in steps S302 and S303, the in-screen distance calculator 110 determines whether there are a plurality of objects and whether the objects are located at a plurality of positions separated by the predetermined distance or more in the depth direction.

When there is a single object or the distance between the objects in the depth direction is shorter than the predetermined length, the AE processor 109 holds the current program diagram in step S309 (the current program diagram is maintained).

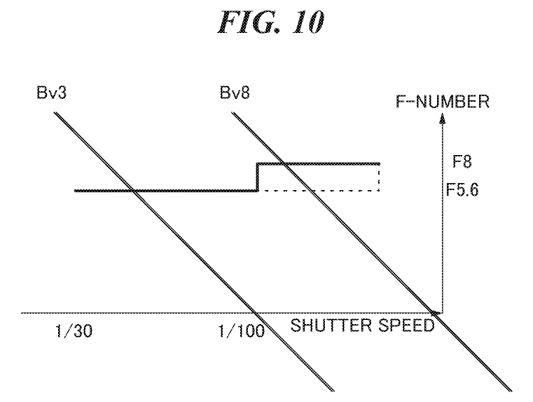

In step S304, the AE processor 109 determines whether the selectable F-number of the lens at that time is equal to or more than a predetermined value. When it is determined that the selectable F-number of the lens is equal to or more than the predetermined value (YES), the process proceeds to the step S309, and when it is determined that the selectable F-number of the lens is less than the predetermined value (NO), the process proceeds to a step S305. For example, as illustrated in FIG. 10, when the F-number corresponding to the current object brightness value Bv3 on the program diagram is “F5.6” and the selectable F-number corresponding to the object brightness value Bv8 is only “F8”, the aperture difference is only one step, and thus the difference in the depth of field is also small, and the expected effect cannot be obtained even if the F-number “F5.6” is maintained.

In such a case, when the selectable F-number or a minimum F-number is equal to or more than “F5.6”, the process proceeds to the step S309 and the current program diagram is held. In addition, in general, a lens of which a focal length is equal to or less than 24mm is referred to as a wide-angle lens. Since the depth of field becomes deeper as the angle of view increases, the wide-angle lens causes the same situation as in the case where the above-described aperture difference is small, and thus, the current program diagram is maintained when using the wide-angle lens. As described above, in the present embodiment, the process of limiting the change of the program diagram according to the type of the lens and the process of limiting the change of the program diagram when the minimum F-number of the lens 1081 or the selectable F-number is equal to or more than the predetermined value are executed. One aspect of the process of limiting the change of the program diagram refers to maintaining the current program diagram without changing the current program diagram (S309: the current program diagram is maintained).

In step S305, the controller 102 determines whether the manual focus (MF) is selected. When it is determined that the MF is selected (YES), the process proceeds to a step S306. When it is determined that the MF is not selected (NO), the process proceeds to the step S309. Next, in step S306, the AE processor 109 calculates an aperture value for each object so that only the object concerned falls within the depth of field. That is, in steps S302, S305, and S306, when there are a plurality of objects and the manual focus is selected, the AE processor 109 calculates an aperture value for each detected person (each object) so that only the person (object) concerned falls within the depth of field.

Next, the AE processor 109 selects an aperture value calculated for an object determined as a “main object” in step S307, and then, calculates a program diagram for change using the selected aperture value and determines that the current program diagram should be changed in step S308. After the process in step S308, S309 or S310 is completed, the process returns to the step S226 in FIG. 2B. When the process returns to the step S226 after the step S308, it is determined that the program diagram should be changed in step S226, and the current program diagram is changed, in step S227, to the program diagram calculated in the S308. When the process returns to the step S226 after the step S310, it is also determined that the diagram should be changed in step S226, and the program diagram is changed to the initial program diagram in step S227. On the other hand, when the process returns to the step S226 after the step S309, it is determined that the program diagram should not be changed in step S226, and the program diagram currently used is held in step S228. Then, the controller 102 performs, in step S229, the exposure control of the image capturing apparatus 10 based on the program diagram changed in step S227 or the program diagram held in step S228.

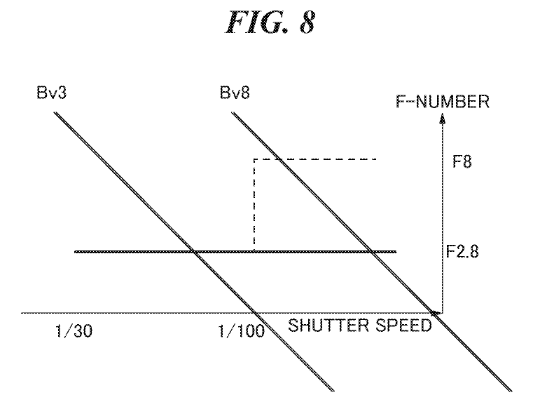

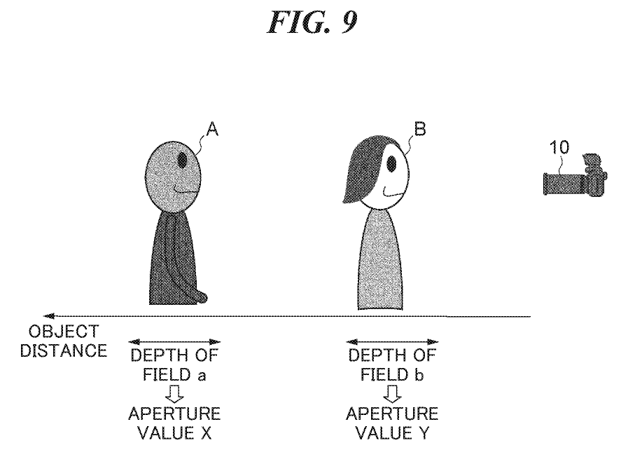

FIG. 8 is a view for describing a program diagram, and FIG. 9 is a view illustrating a relationship between the depth of field and the corresponding aperture. An example of the process in steps S307 and S308 will be described with reference to FIGS. 8 and 9. FIG. 9 shows a case where the object distances to the objects A and B from the image capturing apparatus 10 are measured, and the aperture values corresponding to the objects A and B so that the objects A and B fall within the depths of field “a” and “b”, respectively, are “X” and “Y”. For example, as shown in FIG. 9, when both the aperture values X and Y for the objects A and B are equal to “F2.8”, a line is drawn so as to give priority to “F2.8” as shown in FIG. 8. Therefore, when the program diagram in FIG. 8 obtained by changing the program diagram in FIG. 6 (see a dotted line in FIG. 8) is used, it is possible to perform exposure follow-up from “Bv3” to “Bv8” while keeping the emphasizing effect by the blur.

As described above, according to the present disclosure, the image capturing apparatus 10 includes the sensor unit 103 (the image capturing system) that captures an image and the AF processor 108 (the focusing mechanism) that adjusts the focal position in capturing an image, and allows manual focusing that adjusts a focal position according to a user operation. The object detector 107 detects objects from a captured image, the in-screen distance calculator 110 calculates a depth of field within which an object falls for each of the detected objects, and the controller 102 performs control based on the program diagram related to exposure in capturing an image. In the case where the focal position is adjusted by manual focusing (YES in S305) and it is determined that the plurality of objects respectively falling within the plurality of calculated depths of field satisfy the predetermined condition, the AE processor 109 executes the process in step S308 and determines that the program diagram should be changed. One aspect of the predetermined condition is that a plurality of objects are located at a plurality of positions separated by a predetermined distance or more in the depth direction.

With the above configuration, when an object is switched by a manual focus operation, the program diagram to be used can be appropriately changed and controlled. As a result, it is possible to perform the object change and the exposure follow-up while obtaining an image capturing effect such as an emphasizing effect using “blur” suitable for a user's intention without causing unnatural blur variation.

Further, as shown in steps S306 to S308, when the focal position moves from a first object to a second object, the AE processor 109 controls the aperture value so that the second object after the movement falls within the depth of field and the first object before the movement is outside the depth of field. In addition, when the main object is changed due to the focal position movement, the program diagram is changed so that the aperture value having a larger F-number is preferentially used among the aperture values at which the objects fall within the respective depths of field. As a modification aspect, when the main object is changed due to the focal position movement, the program diagram may be changed to the program diagram that preferentially uses the aperture value having a larger F-number among the aperture values at which the objects fall within the respective depths of field.

According to the present disclosure, when the object to be focused is switched by manual focusing, effects of change of the object to be focused and stable exposure follow-up can be obtained while obtaining an appropriate image capturing effect without unnatural blur variation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-198068, filed November 13, 2024 which is hereby incorporated by reference herein in its entirety.

What is claimed is:

1. An image capturing apparatus capable of manual focusing to adjust a focal position according to a user operation, the image capturing apparatus comprising:
an image capturing system to capture an image;
a focusing mechanism to adjust the focal position in capturing an image;
a memory device that stores a set of instructions; and
at least one processor that executes the set of instructions to:
detect objects from the image;
calculate depths of field within which the objects fall, respectively;
perform control based on a program diagram relating to exposure in capturing an image; and
change the program diagram in a case where the focal position is adjusted by manual focusing and it is determined that the objects respectively falling within the depths of field calculated satisfy a predetermined condition.

2. The image capturing apparatus according to claim 1, wherein the predetermined condition is satisfied when the objects are located at a plurality of positions separated by a predetermined distance or more in a depth direction.

3. The image capturing apparatus according to claim 1, wherein the at least one processor executes instructions in the memory device to:
control an aperture value, in a case where the focusing mechanism moves the focal position from a first object to a second object, so that the second object falls within the depth of field and the first object is outside the depth of field.

4. The image capturing apparatus according to claim 1, wherein the at least one processor executes instructions in the memory device to change the program diagram, in a case where a main object is changed due to movement of the focal position, to a program diagram that preferentially uses an aperture value having a larger F-number among aperture values at which the objects fall within the respective depths of field.

5. The image capturing apparatus according to claim 1, wherein the at least one processor executes instructions in the memory device to change the program diagram to an initial program diagram in a case where it is determined that a second predetermined condition is satisfied.

6. The image capturing apparatus according to claim 5, wherein the second predetermined condition is satisfied when brightness variation in a screen is equal to or more than a preset predetermined value.

7. The image capturing apparatus according to claim 5, wherein the second predetermined condition is satisfied in a case where variation of a gyro signal output by a gyrosensor built in the image capturing apparatus is equal to or more than a predetermined value.

8. The image capturing apparatus according to claim 1, wherein the at least one processor executes instructions in the memory device to limit change of the program diagram according to a type of a lens included in the image capturing system.

9. The image capturing apparatus according to claim 1, wherein the at least one processor executes instructions in the memory device to limit change of the program diagram in a case where a selectable F-number or a minimum F-number of a lens included in the image capturing system is equal to or more than a predetermined value.

10. The image capturing apparatus according to claim 1, wherein the at least one processor executes instructions in the memory device to limit change of the program diagram in a case where a plurality of objects are not detected or the predetermined condition is not satisfied.

11. A control method for an image capturing apparatus that includes an image capturing system for capturing an image and a focusing mechanism for adjusting a focal position in capturing an image and is capable of manual focusing for adjusting the focal position according to a user operation, the control method comprising:
detecting objects from the image;
calculating depths of field within which the objects fall, respectively;
performing control based on a program diagram relating to exposure in capturing an image; and
changing the program diagram in a case where the focal position is adjusted by manual focusing and it is determined that the objects respectively falling within the depths of field calculated satisfy a predetermined condition.

12. A non-transitory computer-readable storage medium storing a control program causing a computer to execute a control method for an image capturing apparatus that includes an image capturing system for capturing an image and a focusing mechanism for adjusting a focal position in capturing an image and is capable of manual focusing for adjusting the focal position according to a user operation, the control method comprising:
detecting objects from the image;
calculating depths of field within which the objects fall, respectively;
performing control based on a program diagram relating to exposure in capturing an image; and
changing the program diagram in a case where the focal position is adjusted by manual focusing and it is determined that the objects respectively falling within the depths of field calculated satisfy a predetermined condition.
